(19) United States
(12) Patent Application Publication
(10) Pub. No.: US 2003/0004860 A1
(43) Pub. Date: Jan. 2, 2003

(54) Method for intermediary trading between building manufacturer and fabrication factory

(75) Inventor: Hiroyuki Terada, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/052,556

(22) Filed: Jan. 23, 2002

(30) Foreign Application Priority Data
Jun. 29, 2001 (JP) 2001-199296

(51) Int. Cl. G06F 17/60

(52) U.S. Cl. 705/37

(57) ABSTRACT

In a method for intermediating trading between a building materials manufacturer and a fabrication factory, order received information is received from a construction company, a fabrication factory satisfying requirements of the order received information is retrieved from a storing part storing fabrication ability information of the fabrication factory. And based on the order received information, fabrication order information is sent to the fabrication factory and building materials order information including information of the fabrication factory, that is a destination to ship building materials from a building materials manufacturer, is sent.

### BACKGROUND OF THE INVENTION

1. Field of the Invention

The present invention generally relates to a method for intermediary trading between a building materials manufacturer and a fabrication factory, in which a building materials fabrication intermediating service is applied to a construction business.

2. Description of the Related Art

For example, conventionally, a builder first makes an order to a construction company. When the construction company receives the order made by the builder, the construction company determines building materials necessary for contents of an order received, and then makes an order of building materials that are determined, to a building materials wholesaler. When the building materials wholesaler receives the order of the building materials, the building materials wholesaler selects a building materials manufacturer for each building-material indicated in the order received.

After that, the building materials wholesaler, which received the order of the building materials from the building materials, ships the building materials to the construction company. The construction company receives the building materials and then manufactures the building materials based on contents of the order received from the builder. When the construction company completes to manufacture the building materials, the construction company ships to a construction location and completes a construction.

According to procedures described above, since the construction company is required to manufacture the building materials received from the building materials wholesaler, the construction company needs a factory. Instead of having a factory, the construction company may make an order of fabrication to a fabrication factory. However, in this case, it is difficult for the fabrication factory to deliver manufactured building materials on time ordered by the construction company because of various order contents and a different order amount every time.

### SUMMARY OF THE INVENTION

It is a general object of the present invention to provide a method for intermediating trading between a building materials manufacturer and a fabrication factory in which the above-mentioned problems are eliminated.

The above objects of the present invention are achieved by a method for intermediating trading between a building materials manufacturer and a fabrication factory, the method including the steps of: (a) receiving order received information from a construction company; (b) retrieving a fabrication factory satisfying requirements of the order received information from a storing part storing fabrication ability information of the fabrication factory; and (c) sending fabrication order information to the fabrication factory and sending building materials order information including information of the fabrication factory that is a destination to ship building materials from a building materials manufacturer, based on the order received information.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a system configuration according to an embodiment of the present invention;

FIG. 2 is a diagram showing an overview of a process conducted in a building materials fabrication intermediating system according to the embodiment of the present invention;

FIG. 3 is a flow chart for explaining an authentication process for a construction company according to the embodiment of the present invention;

FIG. 4 is a flow chart for explaining a receiving process for order received information according to the embodiment of the present invention;

FIG. 5 is a flow chart for explaining an ordering customer retrieving process according to the embodiment of the present invention;

FIG. 6 is a flow chart for explaining a sending process for order information according to the embodiment of the present invention;

FIG. 7 is a diagram illustrating an example of a construction company file according to the embodiment of the present invention;

FIG. 8 is a diagram illustrating an example of a fabrication type file according to the embodiment of the present invention;

FIG. 9 is a diagram illustrating an example of an order received file according to the embodiment of the present invention;

FIG. 10 is a diagram illustrating an example of a fabrication factory schedule file according to the embodiment of the present invention;

FIG. 11 is a diagram illustrating examples of an order information selecting window and a fabrication detail information window according to the embodiment of the present invention;

FIG. 12 is a diagram illustrating examples of a shipping information input window and a fabrication detail information window according to the embodiment of the present invention;

FIG. 13 is a front view of the building materials fabrication intermediating system according to the embodiment of the present invention; and

FIG. 14 is a diagram showing a hardware configuration of the building materials fabrication intermediating system according to the embodiment of the present invention.

### DESCRIPTION OF THE PREFERRED EMBODIMENTS

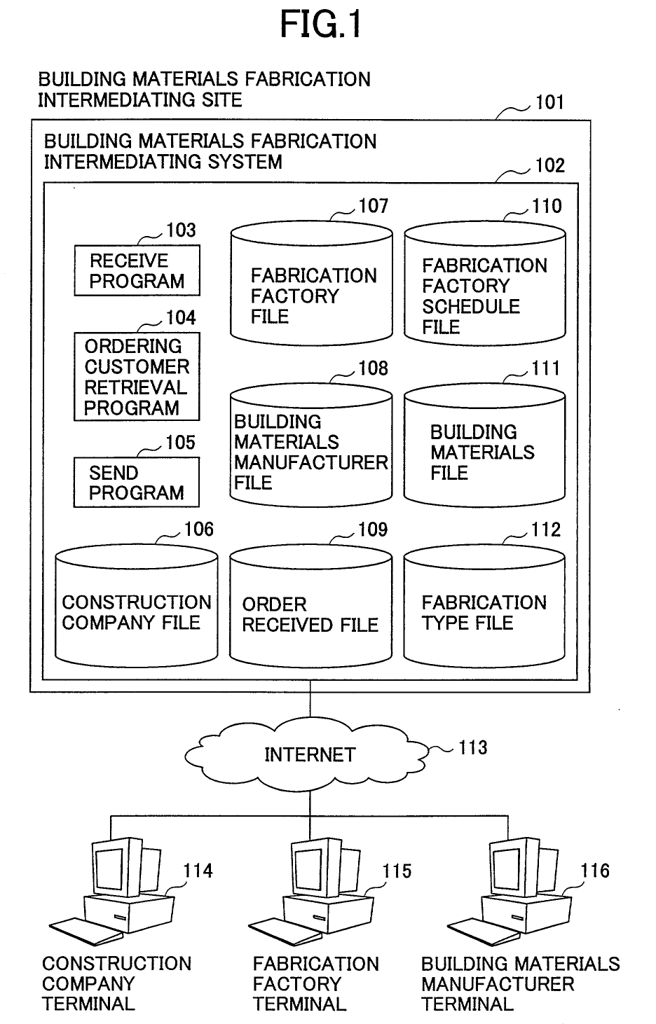

An overview of a system configuration will now be described with reference to FIG. 1, according to an embodiment of the present invention. FIG. 1 is a block diagram showing a system configuration according to the embodiment of the present invention. In FIG. 1, for example, a building materials fabrication intermediating site 101 may be an organization such as an association established by joint investment of a plurality of companies, which organization can be constantly trusted.

In the building materials fabrication intermediating site 101, a building materials fabrication intermediating system 102 is provided as a main computer system in the embodiment of the present invention.

The building materials fabrication intermediating system 102 includes a communication controlling part and for example, connects to a construction company terminal 114 through a network such as an Internet 113.

Moreover, the building materials fabrication intermediating system 102 is connected to a fabrication factory terminal 115 through the Internet 113.

Furthermore, the building materials fabrication intermediating system 102 is connected to a building materials manufacturer terminal 116 through the Internet 113.

The building materials fabrication intermediating system 102 includes a receive program 103 for receiving information from the construction company terminal 114, an ordering customer retrieval program 104 for retrieving and editing order information by accessing each file in the building materials fabrication intermediating system 102 based on the information received from the receive program 103, a send program 105 for sending information to the construction company terminal 114, the fabrication factory terminal 115, or the building materials manufacturer terminal 116.

The receive program 103, the ordering customer retrieval program 104, and the send program 105 are stored in an external storage unit (not shown) of the building materials fabrication intermediating system 102. When executed, each of the receive program 103, the ordering customer retrieval program 104, and the send program 105 are loaded into an internal storage unit.

The external storage unit (not shown) includes a construction company file 106 for storing construction company information, a fabrication factory file 107 for storing fabrication factory information, a building materials manufacture file 108 for storing building materials manufacturer information, an order received file 109 for storing order received information, fabrication factory schedule file 110 for managing open schedules of the fabrication factory, a building materials file 111 for storing building material information, and a fabrication type file 112 for storing fabrication type. Each of files 106 through 112 is referred to or updated by the receive program 103, the ordering customer retrieval program 104, and the send program 105.

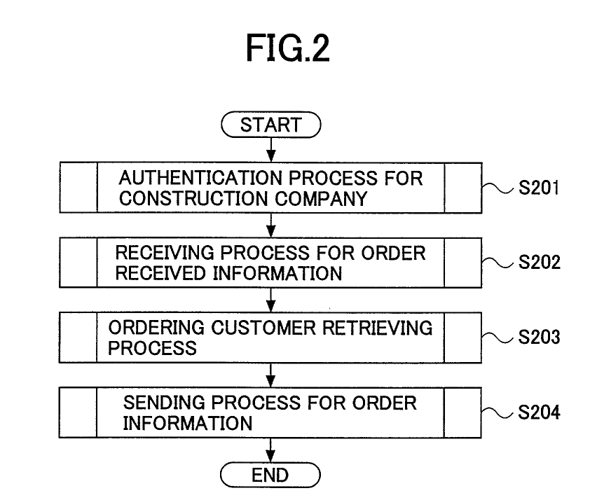

On overview of a process will now be described with reference to FIG. 2, according to the embodiment of the present invention.

In a step S201, an authentication process is conducted for a construction company. When the construction company makes an order of building materials or a fabrication of the building materials, the construction company connects the construction company terminal 114 to the building materials fabrication intermediating system 102 of the building materials fabrication intermediating site 101 through the Internet 113.

A construction company ID and a construction company password are registered with a construction company information concerning the construction company to the building materials fabrication intermediating system 102 beforehand. The construction company is authenticated by sending the construction company ID and the construction company password from the construction company terminal 114 to the building materials fabrication intermediating system 102.

In a step S202, a receiving process is conducted for order received information. The construction company, that is authenticated by the authentication process in the step S201, selects information concerning building materials to be ordered and information concerning a fabrication to be ordered, and sends selection results from the construction company terminal 114 to the building materials fabrication intermediating system 102. Then, the receive program 103 receives the selection results.

In a step S203, an ordering customer retrieving process is conducted. Based on the selection results as the order received information received in the step S202, the ordering customer retrieval program 104 selects an optimal fabrication factory.

In a step S204, a sending process is conducted for order information. The send program 105 sends order information for an order of the building materials to the building materials manufacturer terminal 116 and also sends order information for the order of the fabrication of the building materials to the fabrication factory terminal 115.

Each process shown in FIG. 2 will now be described in detail.

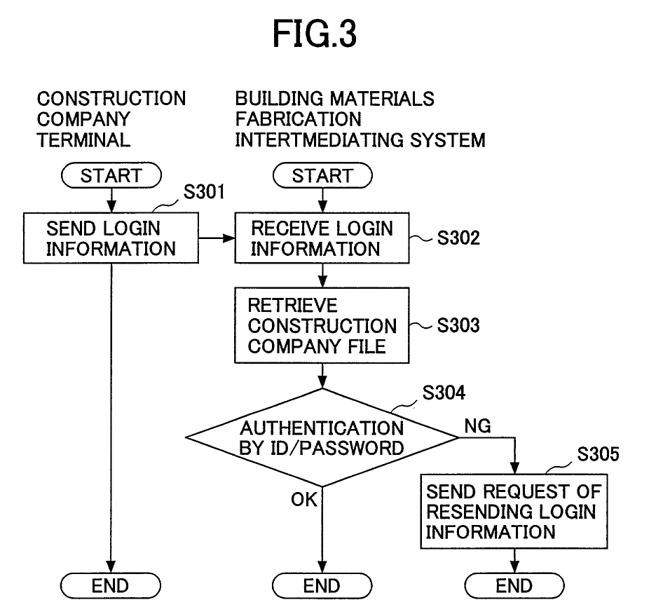

First, the authentication process for the construction company in the step S201 of FIG. 2 will be described in detail with reference to FIG. 3.

In a step S301, the construction company terminal 114 sends login information to the building materials fabrication intermediating system 102. An ordering person of the construction company enters the construction company ID and the construction company password into the construction company terminal 114 and sends the login information to the building materials fabrication intermediating system 102.

In a step S302, the building materials fabrication intermediating system 102 receives the login information sent in the step S301.

In a step S303, the construction company file 106 is searched for.

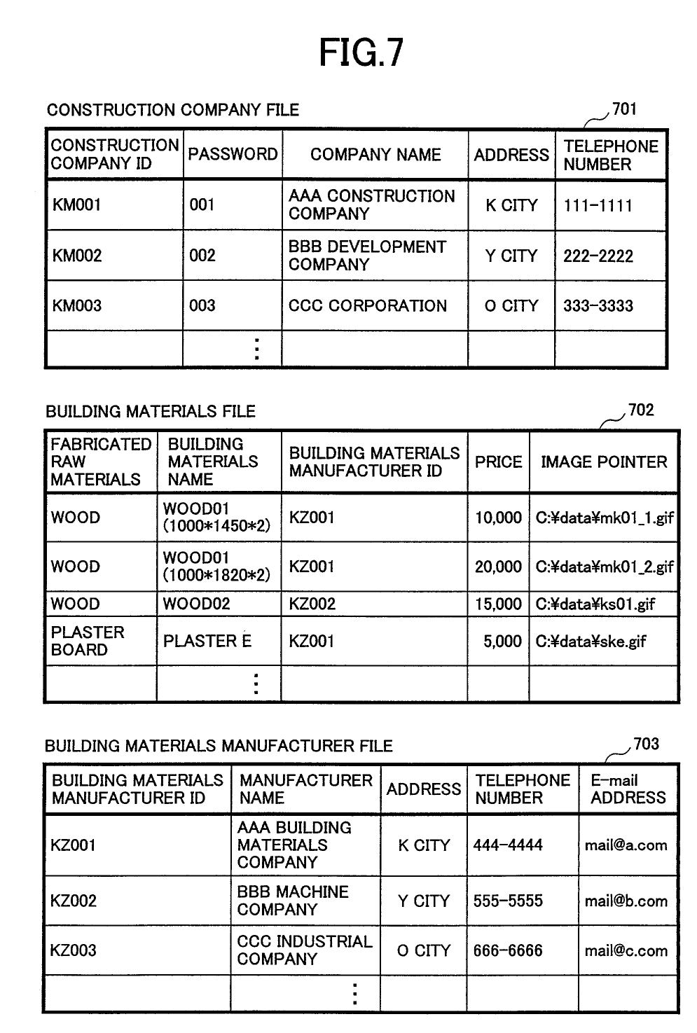

An example of the construction company file 106 is illustrated as a construction company file 701 in FIG. 7. The construction company file 701 includes a construction company ID for identifying the construction company, a password for authenticating the construction company, a company name, and a telephone number.

The building materials fabrication intermediating system 102 retrieves the construction company file 701 by the construction company ID included in the login information received in the step S302 as a find key.

In a step S304, a determination step is conducted to determine one of branched steps based on a retrieval result of the step S303. As a result, when construction company information matches with the find key and a password in the construction company information matches with a password included in the login information, the authentication process is successfully completed. That is, the authentication process in the step S201 is completed for the construction company.

However, as the retrieval result in the step S303, when there is no construction company information matching with the find key, or when there is the construction company information matching with the find key but the password indicated in the construction company information does not match with the password in the login information, the authentication process is abnormally ended. Then, the building materials fabrication intermediating system advances to step S305.

In the step S305, the building materials fabrication intermediating system 102 sends a request of resending the login information to the construction company terminal 114. In this case, the following steps are not executed and the ordering person of the construction company is required to resend the login information to the building materials fabrication intermediating system 102.

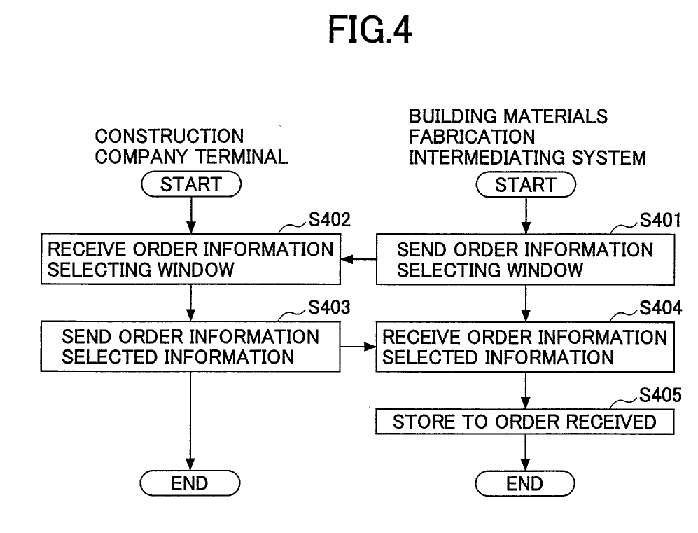

The receiving process for the order received information in the step S202 of the FIG. 2 will now be described in detail with reference to FIG. 4.

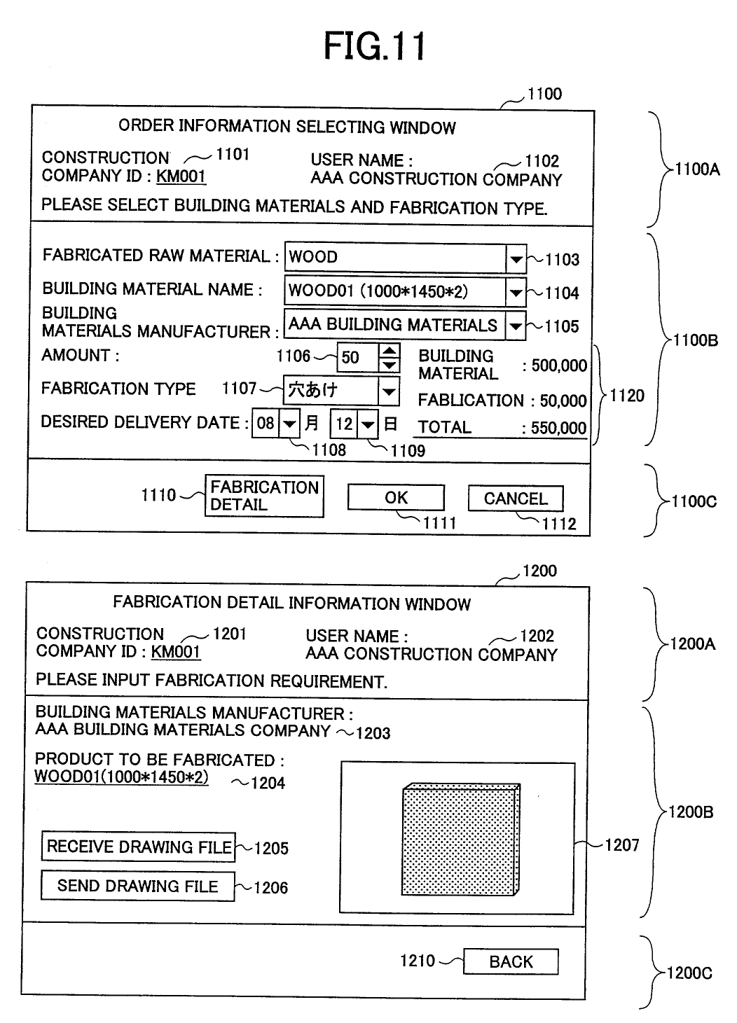

In a step S401, the building materials fabrication intermediating system 102 displays an order information selecting window at the construction company terminal 114. An example of the order information selecting window is illustrated as an order information selecting window 1100 in FIG. 11.

The order information selecting window 1100 includes a header 1100A, a body 1100B, and a footer 1100C. The header 1100A shows the construction company ID that the construction company terminal 114 entered to login, the construction company name obtained by retrieving the construction company file 701 by the construction company ID as the find key.

The body 1100B includes comboboxes 1103 through 1109 for selecting each item of a fabricated raw material, a building material name, a building materials manufacturer, an amount, a fabrication type, and a desired delivery date. When the order information selecting window 1100 is initially displayed at the construction company terminal 114, all items are not selected.

The footer 1100C includes a fabrication detail button 1110, an OK button 111, and a cancel button 1112.

In a step S402, the construction company terminal 114 receives the order information selecting window 1100. The construction company terminal 114 receives the order information selecting window 1100 sent from the building materials fabrication intermediating system 102, and the order information selecting window 1100 is displayed at a display unit (not shown) of the construction company terminal 114.

The ordering person of the construction company selects items of the order information selecting window 1101 displayed at the display unit. The ordering person selects the fabricated material, the building material name, and building materials manufacturer.

In the building material fabrication intermediating system 102, information of the building materials manufacturer is stored in the building materials manufacturer file 108 and information of building materials is stored in the building materials file 111, beforehand.

An example of the building materials manufacturer file 108 is illustrated as a building materials manufacturer file 703 in FIG. 7. The building materials manufacturer file 703 stores a building materials manufacturer ID for identifying the building materials manufacturer, a manufacturer name, an address, and an e-mail address.

An example of the building materials file 111 is illustrated as a building materials file 702 in FIG. 7. The building materials file 702 stores a fabricated row material indicating a raw material of the building material, a building material name, a building materials manufacturer ID linked to the building materials manufacture ID of the building materials manufacture file 703, a price, and an image pointer pointing a location where image data is stored.

The fabricated raw material, the building material, and the building materials manufacturer indicated by the comboboxes 1103 through 1105 of the order information selecting window 1100 are linked to the building materials manufacturer file 703 and the building material file 702. The fabricated raw material, the building material, and the building materials manufacturer are used for the ordering person to specifically target a building material. When the ordering person decides a building material to be ordered, the ordering person selects an amount to be ordered.

When the ordering person selects information necessary to order, a building material price is calculated based on information stored in the building materials file 702 and the amount. A calculation result 1120 is displayed at a right side of the body 1100B in the order information selecting window 1100.

By using the fabrication type and the desired date, information concerning a fabrication for the building material is selected.

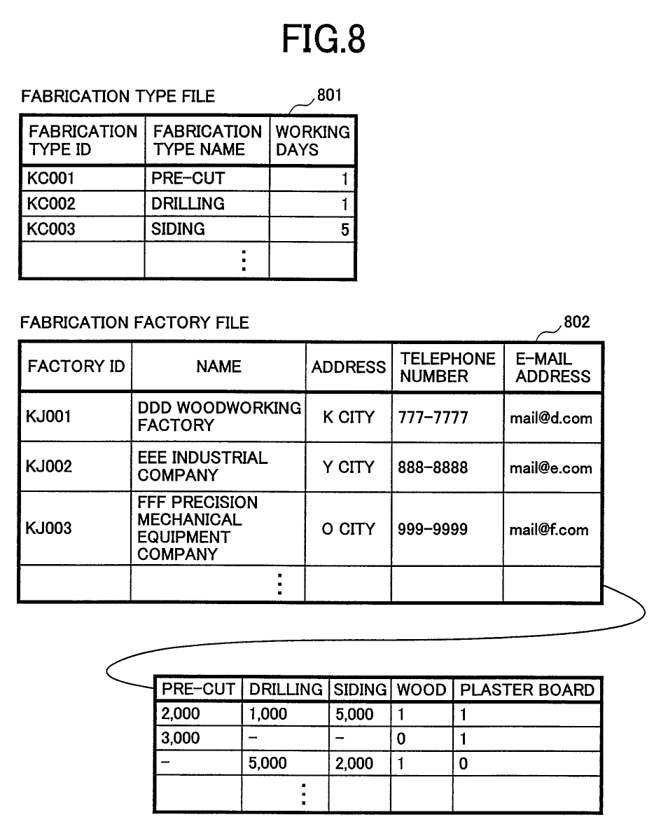

The fabrication type selected from the combobox 1107 on the order information selecting window is linked to the fabrication type file 112. An example of the fabrication type file 112 is illustrated as the fabrication type file 801 in FIG. 8. The fabrication type file 801 stores a fabrication type ID for identifying the fabrication type, a fabrication type name, working days showing days required for a fabrication.

In a step S403, the construction company terminal 114 sends order information selected information to the building material fabrication intermediating system 102. That is, after the ordering person selects the desired delivery date from the comboboxes 1108 and 1109 on the order information selecting window and then clicks the OK button 1111, the order information selected information including the fabricated raw material, the building material name, the amount, the fabrication type, and the desired delivery date is sent to the building materials fabrication intermediating system.

In a step S404, the building materials fabrication intermediating system 102 receives the order information selected information.

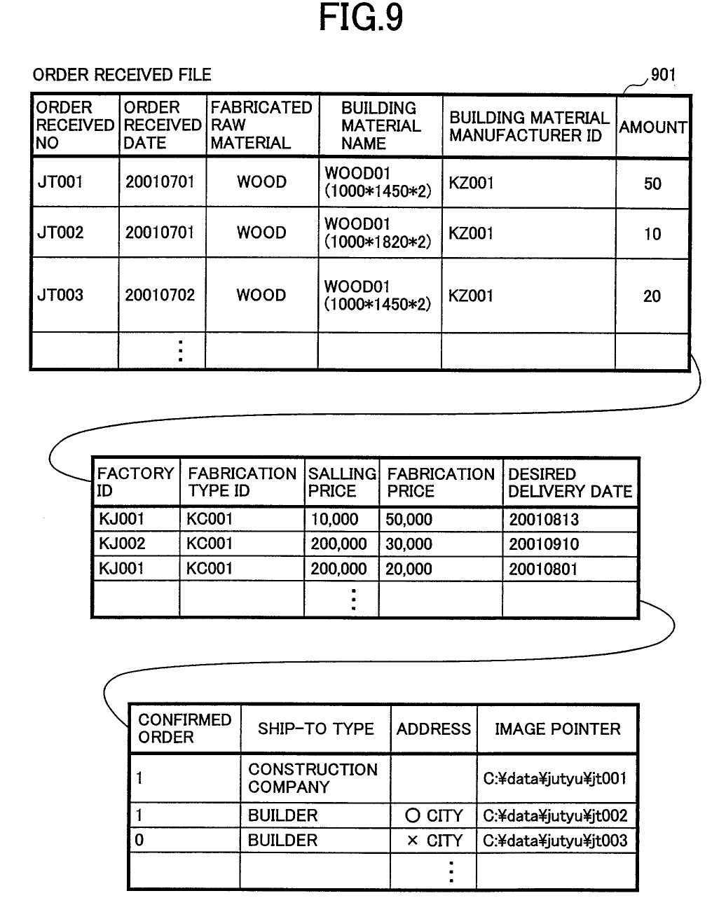

In a step S405, the order information selected information received in the step S404 is stored in the order received file 109. An example of the order received file 109 is illustrated as an order received file 901 in FIG. 9.

The order received file 901 stores items including the order received number for identifying the order received, an order received date, a fabricated raw material, a building material name, building materials manufacturer ID, an amount, a factory ID, a fabrication type ID, a selling price, a fabrication price, a desired delivery date, a confirmed order showing whether or not the order received is confirmed, a ship-to type, an address, and an image pointer indicating a location where an image data file describing fabrication requirements of the building material is stored.

The confirm order shows “1” when an order of the fabrication is confirmed and the confirmed order shows “2” when the order of the fabrication is not confirmed.

At this point, the order received number, the order received, the fabricated raw material, the building material name, the building material manufacturer ID, the amount, the fabrication type ID, the selling price, and the desired delivery date of the items described above are filled in.

That is, the order received number is automatically numbered, and a processed data is set to the order received date. In addition, information, which is retrieved from the building materials manufacturer file 703 by the building material name indicated by the order information selected information as a find key, is set to the building materials manufacturer.

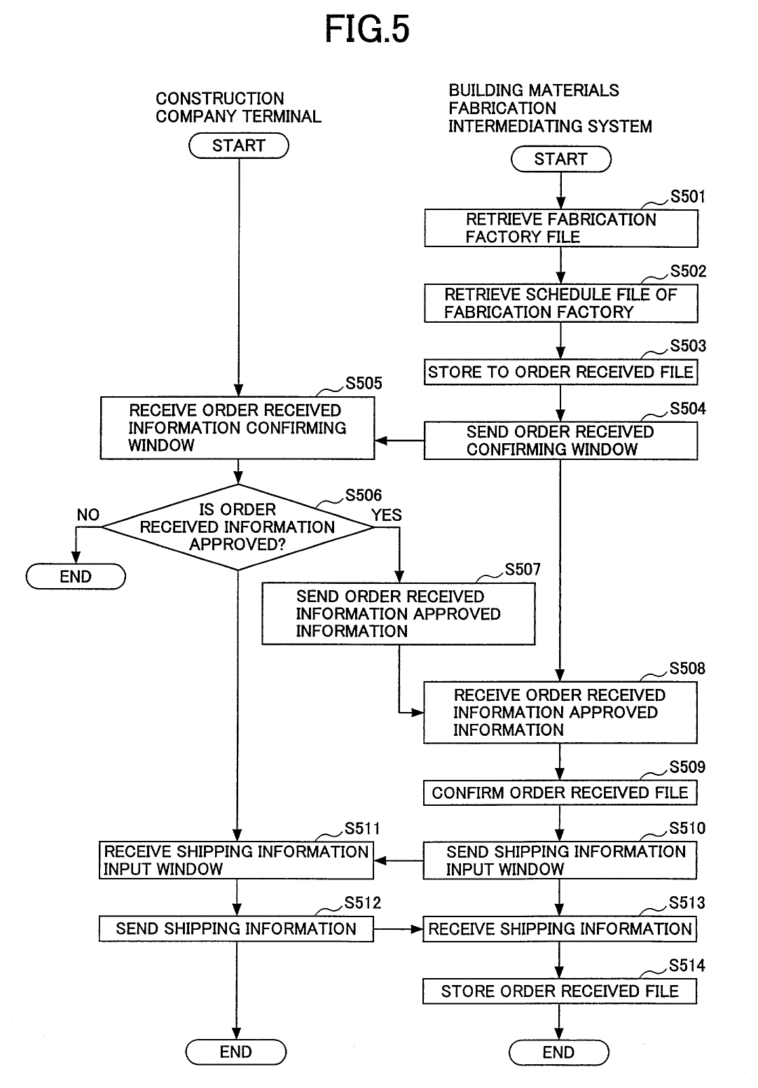

The ordering customer retrieving process in the step S203 of FIG. 2 will now be described with reference to FIG. 5 in detail.

In a step S501, based on information of the order received file 901, the fabrication factory file 107 is retrieved. An example of the fabrication factory file 107 is illustrated as a fabrication factory file 802 in FIG. 8.

The fabrication factory file 802 stores items including a factory ID for identifying the fabrication factory, a name, an address, a telephone number, an e-mail address, a pre-cut showing a precut fabrication per unit, a drilling showing a drilling fabrication, a siding showing a siding fabrication price per unit, a wood showing an allowableness of a wood fabrication, and a plaster board showing an allowableness of a plaster board fabrication.

The wood item and the plaster board item show “1” when the wood fabrication and the plaster board fabrication are allowed, respectively. And the wood item and the plaster board item show “0” when the wood fabrication and the plaster board fabrication are not allowed, respectively.

Based on the fabricated raw material and the fabrication type ID of the order received file 901, the fabrication factory file 802 is retrieved. In detail, if the fabricated raw material of the order received file 901 shows the wood, the fabrication factory file 802 having the fabrication factory, in which the wood item of the fabrication factory file 802 shows “1” (fabrication allowable), is retrieved. If the fabricated raw material of the order received file 901 shows the plaster board, the fabrication factory file 802 showing the fabrication factory, in which the plaster board item shows “1”, is retrieved.

Subsequently, a fabrication type name corresponding to the fabrication type ID of the order received file 901 is retrieved. If the fabrication type name is the precut, the fabrication factory, in which a numeral value is stored to the pre-cut item in the fabrication factory file 802, is searched for. If the fabrication type name is the drilling, the fabrication factory, in which a numeral value is stored to the drilling item, is searched for. If the fabrication type name is the siding, the fabrication factory, in which a numeral value is stored to the siding item in the fabrication factory file 802, is searched for.

The fabrication factory, in which the numeral values are not set to the precut item, the drilling item, and the siding item of the fabrication factory file 802, is one that does not do such specific fabrication. That is, an order cannot be made to such the fabrication factory. Thus, such the fabrication factory is not retrieved.

In a step S502, the fabrication factory schedule file is retrieved. When the fabrication factories are retrieved to satisfy the order requirements of the ordering person of the construction company in the step S501, schedules of retrieved fabrication factories are checked.

The fabrication factories to be ordered are further retrieved from fabrication factories retrieved in the step S501, where a delivery date of each of the fabrication factories matches with the desired delivery date indicated in the order received file 901, based on information of the fabrication factory schedule file 110.

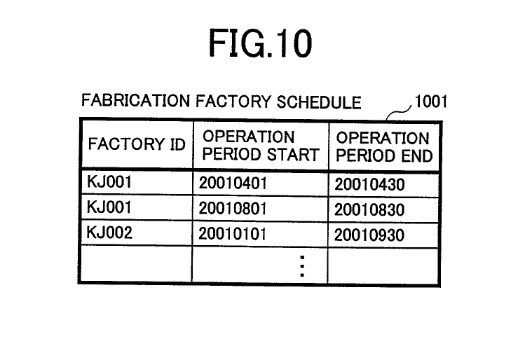

An example of the fabrication factory schedule file 110 is illustrated as the fabrication factory schedule 1001 in FIG. 10. The fabrication factory schedule 1001 stores a factory ID for identifying a fabrication factory, an open period start for indicating a start of an open schedule, and an open period end for indicating an end of the open schedule.

In this case, for example, the working days of the fabrication type file 801 are deducted from the desired delivery date of the order received file 901. A working period is defined from a day resulted from a deduction above to the desired period of the order received file 901. The fabrication factory is defined as an order available fabrication factory where a workable period, which is a period between the open period start and the open period end, includes the working period.

By such a calculation described above in the steps S501 and S502, an optimum fabrication factory, which satisfies a fabrication ability and an open schedule, can be selected.

In a step S503, information of the optimum fabrication factory determined in the steps S501 and S502 stores from the fabrication factory schedule file 1001 to the order received file 901. In detail, the factory ID and the fabrication price are stored. As the fabrication price, price items (the pre-cut, the drilling, and the siding) for the fabrication type are retrieved from the fabrication factory file 802 by the factory ID of the fabrication factory schedule file 1001 as a find key. Then, the price items retrieved are stored.

In a step S504, an order received confirming window is sent to the construction company terminal 114. In detail, the order received confirming window showing the fabrication price and a total price copied form the order information selecting window 1100 is sent to the construction company terminal 114. A configuration of the order received confirming window is the same as that of the order information selecting window 1100, and therefore, an explanation thereof will be omitted.

In a step S505, the construction company terminal 114 receives the order received confirming window. The construction company terminal 114 receives the order received confirming window sent from the building materials fabrication intermediating system 102 in the step S504 and the order received confirming window is displayed at the display unit (not shown) of the construction company terminal 114.

In a step S506, the ordering person of the construction company confirms information shown in the order received confirming window. When the ordering person of the construction company approves the information shown in the order received confirming window, the ordering person clicks the OK button located in the footer. Then, the ordering customer retrieving process advances to a step S507. On the other hand, when the ordering person does not approve the information shown in the order received confirming window, the ordering person clicks the CANCEL button located in the footer. Then, the ordering customer retrieving process is terminated.

In the step S507, order received information approved information is sent to the building materials fabrication intermediating system 102. In detail, it is informed to the building materials fabrication intermediating system 102 that the OK button is clicked in the step S506.

In a step S508, the building materials fabrication intermediating system 102 receives the order received information approved information that is sent from the construction company terminal 114 in the step S507.

In a step S509, the order received information approved information, which is received in the step S508, is stored in the order received file 901. The firm order is set to “1” as the order received is firmed.

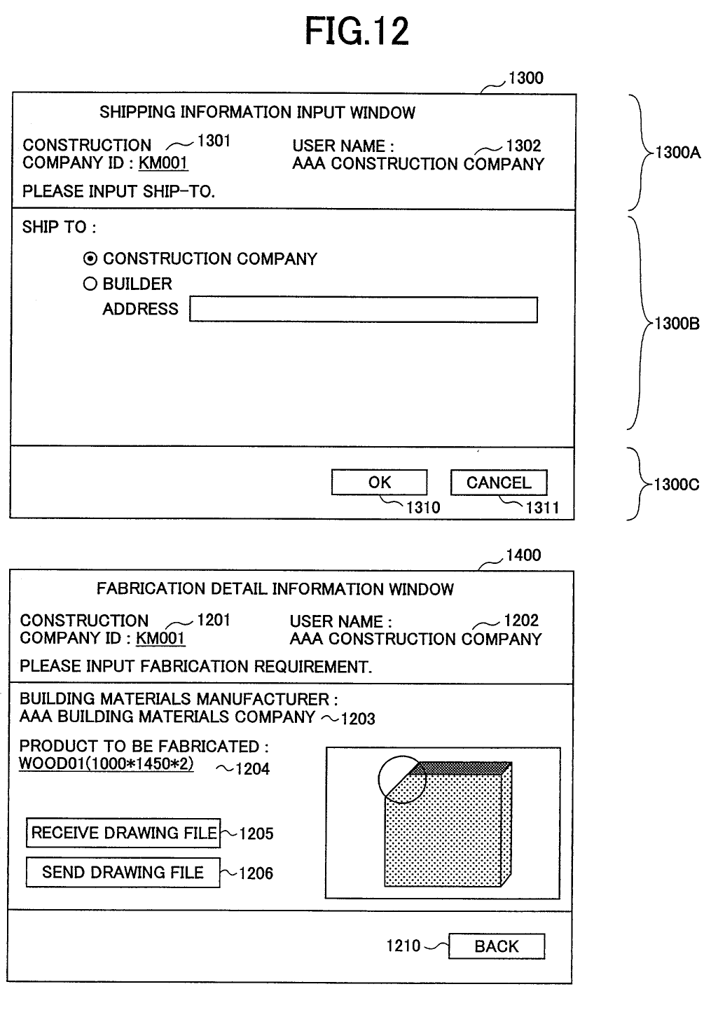

In a step S510, the building materials fabrication intermediating system 102 sends a shipping information input window to the construction company terminal 114. An example of the shipping information input window is illustrated as a shipping information input window 1300 in FIG. 12.

The shipping information input window 1300 includes a header 1300A, a body 1300B, and a footer 1300C. The header 1300A shows the construction company ID 1301 used when the ordering person logs in at the construction company terminal 114 and a user name 1302 showing a construction company name retrieved by searching for the construction company file 701 by using the construction company ID as a find key.

The body 1300B includes radio buttons 1303 and 1304 for a construction company and a builder, respectively, to select either one of the construction company and the builder as a ship-to being a destination where the construction materials are shipped after the fabrication is completed. Since an address of the construction company is stored in the construction company file 701, it is not required for the ordering person to enter the address of the construction company file 701. However, since an address of the builder is not stored in the building materials fabrication intermediating system 102, it is required for the ordering person to enter the address of the builder when the ordering person selects the radio button 1304.

The footer 1300C includes a OK button 1310 and a cancel button 1311.

In a step S511, the construction company terminal 114 receives the shipping information input window 1300. The construction company terminal 114 receives the shipping information input widow 1300 sent from the building materials fabrication intermediating system 102 in the step S510, and displays the shipping information input window 1300 at the display unit (not shown).

The ordering person of the construction company selects information shown in the shipping information input window 1300 displayed at the display unit (not shown). First, the ordering person selects the ship-to by clicking either one of radio buttons 1303 and 1304 on the shipping information input window 1300. When the ordering person selects the builder, the ordering person inputs the address of the builder.

In a step S512, the construction company terminal 114 sends shipping information. That is, the ordering person of the construction company clicks the OK button 1310 provided in the footer 1300C and then the shipping information is sent to the building materials fabrication intermediating system 102.

In a step S513, the building materials fabrication intermediating system 102 receives the shipping information sent from the construction company terminal 114 in the step S512.

In a step S514, the shipping information received in the step S513 is stored in the order received file 901. A ship-to type and the address indicated in the shipping information are stored in the order received file 901.

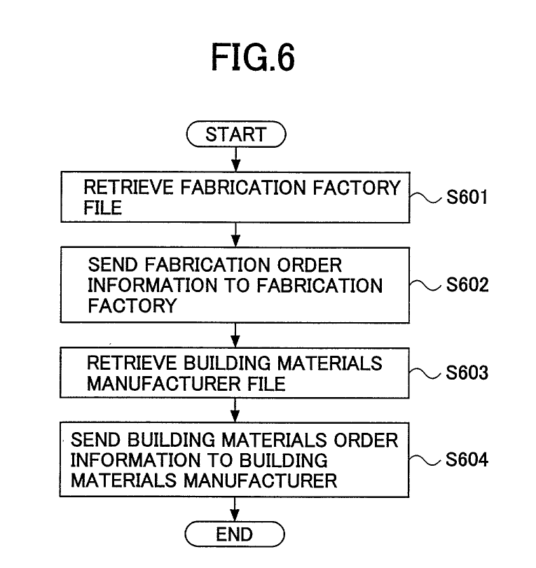

The sending process for the order information in the step S204 of FIG. 2 will now be described with reference to FIG. 6 in details.

In a step S601, the fabrication factory file 802 is searched for. An electric mail address in the fabrication factory file 802 is retrieved by using the factory ID of the order received file 901 as a find key.

In a step S602, fabrication order information is sent to the fabrication factory. For example, information including the fabricated raw material, the building material name, the amount, the fabrication type ID, the fabrication price, the desired delivery date, the ship-to type, and address is retrieved from the order received file 901. Moreover, the fabrication type name is retrieved from the fabrication type file 801 by using the fabrication type ID as a find key. The information retrieved from the order received file 901 is included in a body of an email and sent to the e-mail address obtained in the step S601.

In a step S603, the building materials manufacturer file 108 is searched for. The e-mail address of the building materials manufacturer file 703 is searched for by using the building materials manufacturer ID as a find key.

In a step S604, building materials order information is sent to the building materials manufacturer. For example, information including the building material name, the amount, the factory ID, and the selling price is retrieved from the order received file 901. Moreover, the name and the address are retrieved from the fabrication factory file 802 by using the factory ID as a find key. The information retrieved from the order received file 901 is included in a body of an email and sent to the e-mail address obtained in the step S603.

The building materials manufacturer, which received the building materials order information sent in the step S604, prepares and ships the building materials to the fabrication factory but not the construction company that made the order. And, the fabrication factory receiving the building materials fabricates the building materials. After that, the fabrication factory ships fabricated building materials to the ship-to indicated in the fabrication order information.

In the embodiment as described above, only the fabrication type is indicated and nothing related to fabrication detail information is indicated. Alternatively, image data or CAD data can be used as a concrete image to indicate a fabrication method.

When the ordering person of the construction company clicks the fabrication detail button 1110 provided in the footer 1100C of the order information selecting window 1100, a fabrication detail information window 1200 in FIG. 11 is sent to the fabrication factory. The ordering person can indicate details of the fabricating method for the building materials by using the fabrication detail information window 1200.

The fabrication detail information window 1200 includes a header 1200A, a body 1200B, and a footer 1200C. The header 1200A includes a construction company ID 1201 used when the ordering person logs in at the construction company terminal 114, and a user name 1202 showing the construction company retrieved by searching for the construction company file 701 by using the construction company ID as a find key.

The body 1200B includes information of the building materials selected in the order information selecting window 1100 and also includes a receive drawing file button 1205, a send drawing file button 1206, and an image displaying area 1207.

The footer 1200C includes a back button 1210.

When a drawing file is received, the image displaying area 1207 of the body 1200B displays an image of the building material selected in the order information selecting window 1100. In the image displaying area 1207, the image file, which is indicated by the pointer information stored in the image pointer of the building material file 702, is displayed.

When the order person of the construction company clicks the receive image file button 1205, an image displayed in the image displaying area 1207 is downloaded into a local storage disk of the construction company terminal 114. Then, for example, the ordering person of the construction company makes a mark at a portion to be fabricated, so that the fabricating method is additionally indicated on the image.

After that, when the ordering person clicks the send image file button 1206, the image in which the ordering person additionally indicated the fabricating method is displayed in the image displaying area 1207 of the body 1200B. Also, the image file is sent to the building materials fabrication intermediating system 102.

An example of the fabrication detail information window is illustrated as a fabrication detail information window 1400 in FIG. 12. In the fabrication detail information 1400, it is indicated that a left corner of a top of the building material is cut off.

A configuration of the fabrication detail information 1400 is the same as that of the fabrication detail information 1200 and an explanation thereof will be omitted.

The building materials fabrication intermediating system 102 receives the image file that is edited, and stores the image file to the local storage disk. And the building materials fabrication intermediating system 102 stores the pointer information indicating a storage location to the image pointer of the order received file 901. The ordering person of the construction company clicks the back button 1410 when it is completed to send the image file.

In this case, the fabrication order information sent in the step S602 includes image information indicated by the image pointer of the order received file 901. Then, the fabrication factory conducts a fabrication based on the fabrication order information.

In the embodiment, fabrication details are indicated by using the image file as described above. Alternatively, CAD data can be used.

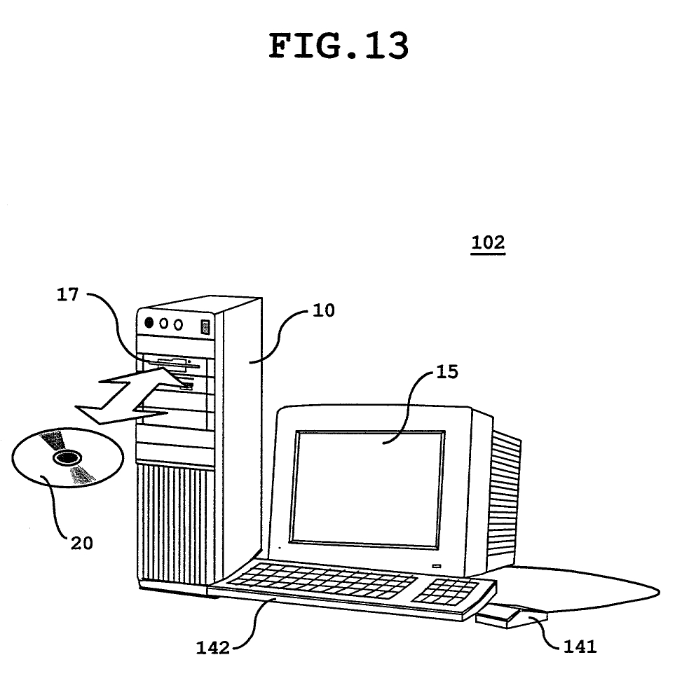

FIG. 13 is a front view of the building materials fabrication intermediating system according to the embodiment of the present invention. In FIG. 13, the building materials fabrication intermediating system 102 as the user terminal includes a main system unit 10 for controlling the building materials fabrication intermediating system 102, a mouse 141 and a keyboard 142 for inputting data, a display unit 15 and a CD-ROM (Compact Disk Read Only Memory) driver 17.

The main system unit 10 connects to and controls the mouse 141, the keyboard 142, the display unit 15, and the CD-ROM driver 17, in order to realize the operations described above. The mouse 141 and the keyboard 142 are used to input data. The display unit 15 displays, for example, the windows 1100, 1200, 1300, and 1400. The CD-ROM driver 17 is used to install various programs related to the method for intermediary trading between a building materials manufacturer and a fabrication factory, from a CD-ROM 20.

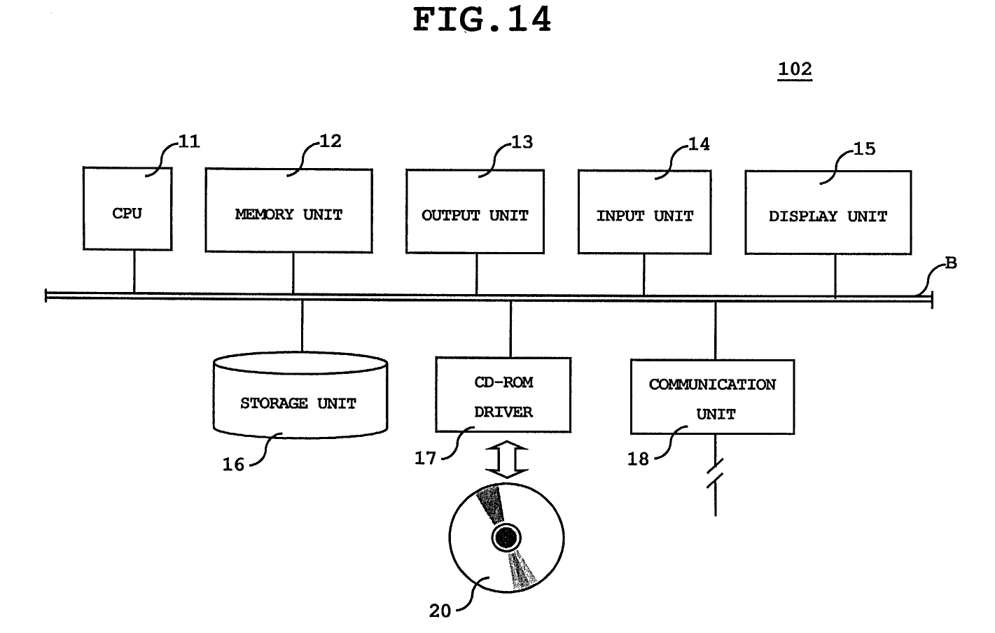

FIG. 14 is a diagram showing a hardware configuration of the building materials fabrication intermediating system 102 according to the embodiment of the present invention. In FIG. 14, the building materials fabrication intermediating system 102 includes a CPU (Central Processing Unit) 11, a memory unit 12, an output unit 13, an input unit 14, the display unit 15, a storage unit 16, the CD-ROM driver 17, and a communication unit 18, all of which are connected together through a bus B. The CPU 11, the memory unit 12, the storage unit 16, the CD-ROM driver 17, and the communication unit 18 are mounted in the main system unit 10 shown in FIG. 13.

The CPU 11 controls the building materials fabrication intermediating system 102 in accordance with programs stored in the memory unit 12 and also executes processes realizing the operation described above. The memory unit 12 includes a RAM (Random Access Memory) and a ROM (Read Only Memory) and stores the programs executed by the CPU 11, data necessary for the processes, and data obtained by the processes. Also, the memory unit 12 is partially used as a working area for the processes executed by the CPU 11.

The output unit 13 includes a printer or the like and is used to output a process result or indicated information. The input unit 14 includes the mouse 141, the keyboard 142, or the like and is used to input information. The display unit 15 displays information for the system manager and the user.

The storage unit 16 includes a hard disk and stores files, databases and, programs. The communication unit 18 controls data transmissions for sending or receiving information.

For example, the programs are installed into the building materials fabrication intermediating system 102 by loading the CD-ROM 20 into the CD-ROM driver 17. That is, when the CD-ROM 20 storing the programs is inserted in the CD-ROM driver 17, the CD-ROM driver 17 reads the program from the CD-ROM 20 and the programs read from the CD-ROM 20 are installed into the storage unit 16 via the bus B. When the process is executed, the CPU 11 executes the process in accordance with the program installed into the storage unit 16.

The method for intermediating a building materials company and a fabrication factory can be stored as a program in a computer-readable recording medium. The method can be realized by a computer executing the program. A magnetic recording medium and a semiconductor memory can be used as a computer-readable recording medium. To be a marketable product, the program is recorded in a portable recording medium such the CD-ROM or a floppy disk, or the program is transmitted to another computer via a network.

As described above, by providing an intermediating site such as the building materials fabrication intermediating site 101 for the building materials that needs to be fabricated, it is possible for the construction company to simply make an order to the fabrication factory. Therefore, it is not required for the construction company to provide any equipment for fabricating the building materials.

The present invention is not limited to the specifically disclosed embodiments, variations and modifications, and other variations and modifications may be made without departing from the scope of the present invention.

The present application is based on Japanese Priority Application No. 2001-199296 filed on Jun. 29, 2001, the entire contents of which are hereby incorporated by reference.

What is claimed is:

1. A method for intermediating trading between a building materials manufacturer and a fabrication factory, said method comprising the steps of:
(a) receiving order received information from a construction company;
(b) retrieving a fabrication factory satisfying requirements of said order received information from a storing part storing fabrication ability information of said fabrication factory; and
(c) sending fabrication order information to said fabrication factory and sending building materials order information including information of said fabrication factory that is a destination to ship building materials from said building materials manufacturer, based on said order received information.

2. The method as claimed in claim 1, wherein said order received information includes fabrication indication information in which an indication is shown by image data.

3. The method as claimed in claim 1, wherein said fabrication ability information includes open schedule information of said fabrication factory.

4. An apparatus for intermediating trading between a building materials manufacturer and a fabrication factory, said apparatus comprising:
a receiving part receiving order received information from a construction company;
a retrieving part retrieving a fabrication factory satisfying requirements of said order received information from a storing part storing fabrication ability information of said fabrication factory; and
a sending part sending fabrication order information to said fabrication factory and sending building materials order information including information of said fabrication factory that is a destination to ship building materials from said building materials manufacturer, based on said order received information.

5. A computer-readable recording medium having program code recorded therein for causing a computer to intermediate trading between a building materials manufacturer and a fabrication factory, said program code comprising the code for:
(a) receiving order received information from a construction company;
(b) retrieving a fabrication factory satisfying requirements of said order received information from a storing part storing fabrication ability information of said fabrication factory; and
(c) sending fabrication order information to said fabrication factory and sending building materials order information including information of said fabrication factory that is a destination to ship building materials from said building materials manufacturer, based on said order received information.
